(19) United States
(12) Patent Application Publication
(10) Pub. No.: US 2014/0244463 A1
(43) Pub. Date: Aug. 28, 2014

(54) System and Method for Entering, formatting, Sharing and Validating Credit Data Between Businesses and Creditors

(71) Applicant: Descant, Inc., Portland, OR (US)

(72) Inventor: LaVonne Reimer, Portland, OR (US)

(73) Assignee: Descant, Inc., Portland, OR (US)

(21) Appl. No.: 14/189,826

(22) Filed: Feb. 25, 2014

Related U.S. Application Data
(60) Provisional application No. 61/769,101, filed on Feb. 25, 2013.

(51) Int. Cl. G06Q 40/00

(52) U.S. Cl. CPC G06Q 40/00
USPC 705/35

(57) ABSTRACT

A system and method for assisting firms enter, format, and validate their financial data with their creditors easily, with greater integrity and greater transparency in credit practices. The system allows for input of a firms financial data, formatting that data into industry standard business format, and allow for secure sharing of that information between businesses, partners and creditors. The system maps idiosyncratic data representations and similar forms of semi-structured data to a single standard taxonomy, allows users to improve and approve the mapping, and learns from those users' actions to improve the fidelity of the translation over time. The system uses a firms' own actions on a financial data sharing site to establish a measure of their data's integrity, accuracy, and trustworthiness.

### CROSS-REFERENCE TO RELATED APPLICATION

This application claims priority to U.S. Provisional Application Ser. No. 61/769,101 filed Feb. 25, 2013, and is incorporated herein by reference in its entirety.

### FIELD

The system and method disclosed generally relates to business methods and systems for users to aggregate, share, and collectively validate credit information.

### BACKGROUND

Organizations (creditors) doing business with privately held firms must verify the soundness of each business and its ability to honor the conditions of the credit agreement. For credit decisions involving disbursement of money, such as bank loans and customer procurement, the legacy system and methods—credit bureau supplied scores—are insufficient. These decisions are based on the creditor's ability to evaluate and continuously monitor the essential business and financial data of the firm. The burden to supply such data falls on each firm.

For privately held firms, many of which are small- and mid-sized businesses (SMBs), the process of supplying and analyzing information that includes data such as financial reports causes errors, delays, and limited visibility along the entire process. Financial data for SMBs are highly non-standard. Presently, each firm manually edits financial reports via spreadsheets that are often transmitted by fax where they are manually re-keyed into creditor systems.

Privately held firms encounter the problem of non-standard financial data every time they must supply proof of the soundness of their business and their ability to honor the conditions of agreements with major creditors such as their lenders, investors and customers. Such proof is typically required at the initial evaluation and periodically over the term of the agreement and/or life of the commercial relationship. Either the firm supplying or organizations receiving the data (often both) must manually normalize the supplied data to a standard taxonomy. This creates additional friction in SMB access to bank loans and similar financing as well as procurement approvals for enterprise and government sales.

Firms in the SMB market often do not have Chief Financial Officers or staff with sufficient skills to understand the best way to edit and present financial data to their creditors. In many cases, they hire outside consultants to prepare data and reports or the Chief Executive Officer (CEO) or other senior executive does the work. Because creditors such as banks and procurement departments require periodic reports and updates, either option creates a significant operating expense for the firm.

In addition, the multiple manual steps along the credit reporting process introduce a high risk of errors. Furthermore, this process, whether conducted with a regulated creditor such as a commercial bank or an unregulated creditor such as an enterprise procurement department, makes it difficult for firms to detect material errors that prevent them from securing favorable deals and result in lost opportunities.

The off-line nature of a manual process limits visibility for both the firm being evaluated and the creditor. The firm cannot easily determine whether, when and by whom their data are viewed as well as how they are being evaluated. Creditors cannot easily monitor such firms in a manner that would help them identify new opportunities, provide meaningful counsel, and mitigate risk exposure.

With publicly traded firms, the Securities and Exchange Commission is in a position to drive standardization in formats used to report business and financial data. There is no such regulatory body or standard for the privately held firms in the SMB market. The absence of a central body or standard along with variations in business models, level of financial expertise, and accounting software make SMB financial data uniquely non-standard. While some major creditors have attempted to impose financial data formats on the SMB market, the market's fragmentation and pervasive lack of resources undercut compliance.

In essence what is required is a system and method for small and medium businesses, SMBs, to capture and format their financial data into an industry accepted standard and to securely share that standardized information with their major creditors including lenders, partners, and other financial stakeholders while meeting creditor requirements of independent verification.

### SUMMARY

The system and method disclosed leverage cloud-based architectures and the commercial relationships among firms and their respective creditors to streamline credit reporting and greatly improve data quality and fidelity. It allows firms to use a social networking-like interface backed by an interactive machine learning system to share their financial data with creditors. Data can be easily uploaded and/or synced from cloud-based data services, auto-standardized, kept up to date, and shared repeatedly with as many creditors as needed. The disclosed system ingests data and captures explicit and implicit actions of the participants in these commercial relationships to aid analysis, normalization, and verification. Business users view their own firm's data in the context that will be seen by creditors, all to deliver new value to them for having provided data quantity and quality. Creditors make credit decisions that are more transparent, collaborative and consistent, all to improve their understanding of each business, optimize returns, and mitigate risk.

The present application discloses a method that allows firms to use the disclosed cloud-based system to share their business and financial data with their creditors with a minimum of effort. The disclosed system parses supplied data, typically originating in a summary report, to discrete data objects and attempts to map each such object to a common taxonomy of categories and sub-categories. The data are restructured according to suggested mapping and presented to the user for review and modification. The mapped categories are shown as “tags” or text labels that are shown next to the user's original labels. The user is able to move these tags to other rows of data, remove them, or add additional tags. If a suitable tag is not found the user can suggest a new tag. When users are satisfied with the mapping defined by the application of the tags, they submit that mapping to the system. Mapping from the previous session is preserved; obviating the need to repeat the mapping exercise when the user uploads additional data or the system auto-updates data unless something has changed in the way the firm is representing its financial performance. Additionally, the disclosed system aggregates tag mappings from all sessions and uses them to inform the initial parsing and mapping of data from new users. In this way, the system continuously learns from all user activity, improving its ability to parse and map new data and reducing the amount of review and modification needed by subsequent users. Over time, standards will organically emerge that can take arbitrary financial data from any given firm and automatically map them to such standard taxonomies.

The presently disclosed system and method provides firms with enhancements to credit evaluation and monitoring activities that are not available or are costly and difficult in a manual process. Firms may create unique views of their data for an unlimited number of stakeholders by choosing access rights auto-generated by the system or configuring new views in a fine-grained manner. New and modified visualizations of data such as financial reports and reports may be generated for immediate and selective or generalized publication with no additional programming required. Firms may grant creditors continuous visibility to financial performance and creditworthiness in an automated manner. Furthermore, the pooling of data for comparative views are optimized and anonymized to permit access by any user without disclosing identifying information of the specific entities that contributed to the aggregates while supporting meaningful and fair comparisons.

The presently disclosed system and method establishes the validity and accuracy of user-supplied data through contextual and social information derived from the activities associated with the data rather than by solely auditing the data itself. By observing and analyzing the activities of the firm that owns the data and the other users invited by the firm to observe and interact around the data, the system and method can infer degrees of accuracy and trustworthiness to the data itself. Creditors can be provided this analysis in a simple way that makes credit decisions quicker and more accurate. This further addresses business and regulatory requirements that the bases for credit decisions and evaluations be independently verified.

These and other features of the invention will be more readily understood upon consideration of the attached drawings and of the following detailed description of those drawings and the presently-preferred and other embodiments of the invention.

### BRIEF DESCRIPTION OF THE DRAWINGS

FIG. 1 illustrates the basic system architecture.

FIG. 2 illustrates the interface for creating groups for the sharing of the financial data.

FIG. 3 illustrates the interface by which a firm invites a creditor to a private group the user created.

FIG. 4 illustrates collaboration between a firm and a creditor who is invited by a firm to view their data.

FIG. 5 illustrates the interface that allows a user to upload his or her firm's financial data.

FIG. 6 illustrates the initial review screen that allows the user to ensure his or her firm's data have been properly uploaded.

FIG. 7 illustrates the screen where a user is shown the parsed, uploaded data and is able to adjust initial mapping through the use of “tags.”

FIG. 8 illustrates the interface for viewing activities of the kind that are observed and analyzed for trust assessment.

FIG. 9 illustrates an embodiment of the claimed method.

FIG. 10 illustrates another embodiment of the claimed method.

FIG. 11 illustrates another embodiment of the claimed method.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

The system 100 is comprised of a database 120, mobile servers 180 and web servers 190, and finally portable electronic devices 225, desktop and laptop computers 210, tablets, and smart-phones in which users 220 can access the system. The users access the information over a network 200, such as the internet, in order to access the database 120 information and to transfer and receive information. Firewalls on the user side and database side protect the system and client information.

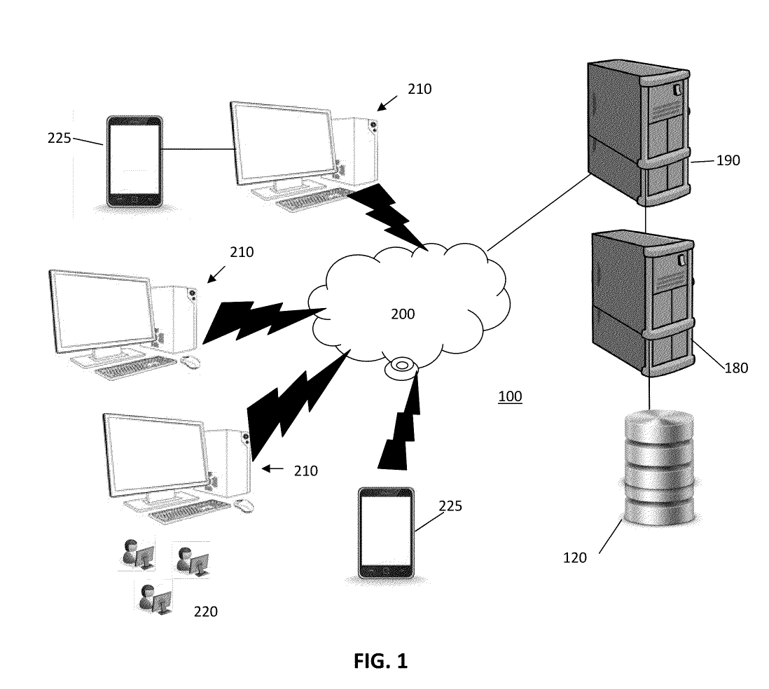

FIG. 1 depicts the basic system architecture for one embodiment. The database 120 stores information for small and medium businesses. The database 120 is a computer database accessible via electronic communication which contains information (e.g. financial data) the small to medium business, data investors, and creditors would prefer to view in certain commercially acceptable formats. The database 120 is periodically updated, e.g. daily or continuously, to include the most accurate, up-to-date information. In one embodiment, the database 120 used is an indexed flat file database. The database 120 is communicatively connected to a database server 180, and may reside on the database server 180 or on a separate computer and/or one or more separate database storage devices. The database server 180 hosts a database management system for managing the steps of writing and reading data to and from the database. The database server 180 controls the flow of information to and from the database 120.

The database server 180 is communicatively connected to a web server 190. The web server 190 hosts information, documents, scripts, and software needed to provide user interfaces and enable performance of methodologies in accordance with an exemplary embodiment of the system and method. By way of example and not limitation, the web server 190 may include web page information, documents and scripts (e.g. HyperText Markup Language (HTML) and Extensible Markup Language (XML)), applets, and application software, which enables users to submit valuation requests and display valuation data in response to valuation requests from users. The web server 190 connects the database server 180 to the network 200 such as the internet.

In one embodiment, access to the web server 190 is accomplished through use of a personal computer 210 which is electronically connected to the network 200. This connection may be through a wired or wireless local area network.

A plurality of users 220 may access the web server 190 using compatible computing devices with network connectivity. By way of example, such devices may include personal computers, laptop computers, handheld computers, personal digital assistants, tablets, mobile phones or any compatibly equipped electronic computing devices. User computing systems may include an operating system and a browser or similar application software configured to properly process and display information, documents, software, applications, applets and scripts provided by the web server. Although three personal computers 210, and two portable electronic devices 225 are shown for illustrative purposes, any number of user computers and portable electronic devices may be used in accordance with the invention.

In one embodiment, access to the web server 190 is accomplished through use of a portable electronic device 225 which electronically connects to the internet. The portable electronic device 225 can electronically connect directly to the internet or be operably connected to a personal computer 210 which connects to the internet.

In one embodiment, a user may access the system through a personal computer 210 through use of a web browser.

The users 220 access the database 120 and its financial business database through an application programming interface (API). An application programming interface is a protocol intended to be used as an interface by software components to communicate with each other.

The system 110 is not limited to any particular network connectivity or communication protocol. Various forms of communication networks may be used by personal computers or portable electronic devices to access the web server. By way of example and not limitation, a proprietary Wide Area Network (WAN) or a public WAN, such as the Internet, may be used. These networks typically employ various protocols such as the HyperText Transfer Protocol (HTTP), File Transfer Protocol (FTP), Extensible Markup Language (XML), and Transfer Control Protocol/Internet Protocol (TCP/IP) to facilitate communication of information between communicatively coupled computers. The system may also utilize wireless networks, including those utilizing Global System for Mobile (GSM), Code Division Multiple Access (CDMA) or Time Division Multiple Access technology, Wireless Application Protocol (WAP), and Long Term Evolution (LTE). Furthermore, the system may utilize any, all, and any combination of such communications networks, as well as communications networks hereafter developed.

The computing devices described herein (e.g., personal computers, handheld computers, servers, portable electronic devices) may be comprised of commercially available computers, hardware and operating systems. The aforementioned computing devices are intended to represent a broad category of computer systems capable of functioning in accordance with the present invention. Of course, the computing devices may include various components, peripherals and software applications provided they are compatible and capable of performing functions in accordance with the present invention. The computing devices also include information, documents, data and files needed to provide functionality and enable performance of methodologies in accordance with an exemplary embodiment of the invention. The computers and electronic systems disclosed consist of processors which perform the electronic steps capable of performing the methods disclosed herein.

A firewall may be located between web server 190 and the database server 180 to protect against corruption, loss, or misuse of data. The firewall limits access by the web server and prevents corruption of data. Thus, the web server may be configured to update and receive data only to the extent necessary. The firewalls may be comprised of any hardware and/or software suitably configured to provide limited or restricted access to the database server 180. The firewalls may be integrated within the database server 180 or another system component, or may reside as a standalone component.

Functions and process steps described herein may be performed using programmed computer devices and related hardware, peripherals, equipment and networks. When programmed, the computing devices are configured to perform functions and carry out steps in accordance with principles of the invention. Such programming may comprise operating systems, software applications, software modules, scripts, files, data, digital signal processors (DSP), application-specific integrated circuit (ASIC), discrete gate logic, or other hardware, firmware, or any conventional programmable software, collectively referred to herein as a module.

The application runs on separate database and application servers. Access to the database is allowed only by the application itself or administratively through accounts held by the provider. All connections of any kind to any aspect of the system are encrypted and secure. Users accessing the application must be named with no guest or anonymous usage permitted. Administrative account-holders have access only to business logic and user account information and not to user-identified data. Aggregate data are anonymized and accessed through a separate code base to ensure that comparative data analytics and query tools cannot be used as a means of attacking the system.

The system 100 and method disclosed permit users 244 to authorize the system 100 to continuously collect and update data 240 from any number of cloud-based systems and services 500. The application manages all activities and analysis associated with these data across multiple levels of access rights 400 including user-only, firm-only, private groups, user-accessible collective views, and derivations from collective analysis such as scores and recommendations.

The system 100 and method permits access by the application on behalf of named users 244 with designated privileges. For financial data, such privileges may be specified at the cell or object level rather than a row or table. Firms select user 244 access rights upon creating private groups that trigger rights at the most granular level. In this manner, the system 100 will expose data associated with cell-specific rights granted by the firm to the group. Added layers of protection prevent participants of one group from gaining non-permitted access to other groups.

The system 100 and method disclosed is a web-based service that allows firms to create a profile, upload and/or sync essential data including financial reports 240 and selectively share that data with one or more creditors 500. Private data such as financial reports are organized at the source to be viewed as summary information typically in a spreadsheet-like format. Either accounting software or each firm may further secure such data 240 to prevent recipients from intentionally or inadvertently corrupting them. Such data 240 are first parsed by the system 100 in order to initiate the method to normalize the firm's data against a common taxonomy 242 and perform additional analysis as required in major creditor evaluations. For example, a balance sheet report will be parsed by the system 100 and stored as a body of individual cells each of which carry attributes from the source report as well as attributes provided by the user upon creating a profile. Source report attributes typically include a line item name from the firm's chosen chart of accounts, a date, the type of report (in this example balance sheet), and the state of the report (in this example, history or forecast). User-supplied attributes 248 may include but are not limited to firm's stage of maturity, region, target market, number of employees, and organizational model.

Parsed data 242 are first visualized for the user 244 in the original format for confirmation that the source data are correctly read by the system 550 and then are visualized as reconstituted according to recommended tags 600. The data and recommended tags are then presented to the user 244 who may modify the system's initial normalization attempt by adding, deleting or editing tags to accurately represent and classify their firm's financial performance or forecasts. When mapping is complete, the system 100 further processes the data to produce key metrics and visualizations that creditors need in order to properly evaluate the firm. In this way users 244 are able to see the way their firm will be viewed by their creditors when they invite them into the system 100.

With the data for a firm loaded into the disclosed system, the firm is able to share selected portions as desired with multiple creditors without additional effort. The user 244 may select from system-generated access rights or customize presentations. In either case, the system 100 sorts through the body of cell-level data according to attributes gathered from implicit and explicit actions to create the desired level of access. The disclosed system 100 also applies the firm's previously approved parsing and mapping to subsequently uploaded data which makes it possible to keep such information up-to-date for ongoing reporting obligations as well as modify previously authorized access rights with very little effort.

By enabling many-to-many exchanges of data between firms and creditors 700, the disclosed system 100 is able to aggregate data and learn from all interactions for the purposes of verifying data fidelity as well as deriving new bases for analysis including comparative baselines 490. In the example of a balance sheet, the system continues to add non-identifying attributes 246 and identifying attributes 248 to each stored cell of financial information that may be used to generate recommendations 495, enrich the context for understanding and predicting performance of each firm. The system 100 will associate actions such as the number of times a data object has been made available for identified views by an invited user 244, the number of times such an invited user 244 has viewed that data object, the frequency of use of the system by such an invited user 244, the number of times that data object has been over-ridden by updates, and the number of times it has been queried in the context of non-identified aggregates.

By deploying in cloud-based architectures, the system and method are able to continuously assign new attributes to each data object, permit users 244 to conduct analysis to meet credit practices as they evolve, and support rich comparative views without jeopardizing the privacy and security concerns of both firms and their creditors 300. This level of visibility combined with fine-grained data security allows regulated creditors such as Federal Deposit Insurance Corporation (FDIC)-insured lenders to balance client management with compliance obligations.

By associating data objects with continuous additions of identifying and non-identifying objects, each embodiment of such data may be accompanied by automated credit recommendations 495. For example, a user 244 with the right to view metrics derived from a balance sheet but not the balance sheet report may receive recommendations such as a note that the firm to which the metric pertains is in the top 10 percent of like firms that are good credit risks 490 or that the user may request additional access rights. In the case of a user 244 with the right to view all financial metrics and high-level information in report format, the user 244 may receive a recommendation to request additional information to verify the nature of short-term assets and liabilities of the firm. In the case of a user 244 with the right to view detailed income statement information, the user may receive a recommendation to request a forecast for the next 12 months or additional years of history in order to meet the user's credit evaluation processes or regulations. In the case of the firm to which any such data pertain, the user 244 may receive a recommendation to seek additional or alternative forms of financing as a result of compliance with credit evaluations or as a result of comparisons to financing vehicles in use by like firms.

When the number of firms substantially similar to any specific user grows to at least 20 firms other than the user, the system and method may generate specific recommendations to grant or deny credit to the user accompanied by further detailed recommendations including but not limited to steps the firm may take to improve its ability to gain credit and steps the creditor may take to help the firm gain credit or to mitigate risk associated with granting credit to the firm.

In the case of patterns of behavior for verification purposes, a participating firm can be compared against the larger population of users to establish additional heuristics to determine overall trustworthiness of supplied credit information. For example, questions may be raised as to the relative validity of data from a firm that has updated their data significantly less often, has not invited as many creditors, or has fewer, less active discussions than their peers. Creditors can request that the firm provide more data or explain these anomalies in order to complete their evaluation. Further, the present system 100 continuously aggregates financial data in order to provide both firms and creditors with access to near real-time baseline metrics against which they may benchmark financial performance. Firms can use these data to see how they are doing relative to their peers as determined by non-identifying attributes such as their industry and/or region. Creditors can use baselines as a further input into their evaluation of a particular firm.

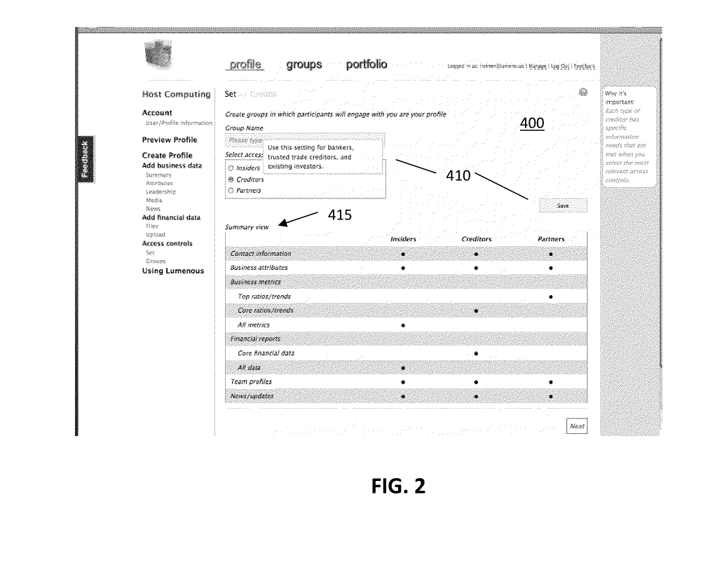

FIG. 2 depicts the profile view from the system application 400. In one embodiment, this view allows users 244 to create groups in which participants will engage with the user 244 and view the user's business profile 410. The application allows users to edit the types of information available to insiders, creditors and business partners. In one embodiment, the summary view of profile information 415 can include contact information, business attributes, (such as top ratios, core ratios/trends, metrics, etc.), financial reports including core financial data, team profiles and news/updates.

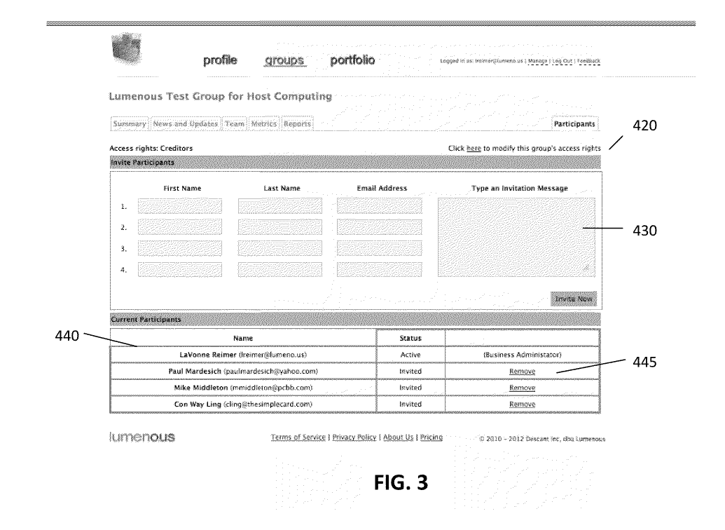

FIG. 3 depicts the groups view from the system application. In one embodiment, this view allows users 244 to modify access rights for the group 420. The application allows users 244 to invite 430 participants to access information in the system 100 and lists current participants 440 and their status of participation. The page also allows users to remove participants 445 as desired.

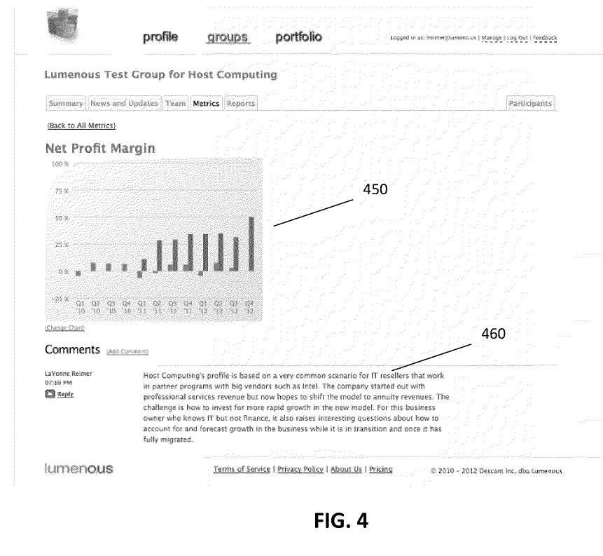

FIG. 4 depicts one embodiment of the metrics page for the system application. In one embodiment, upon selection by the authorized user 244 from all available metrics in the permitted view, the Net Profit Margin 450 may be displayed for the user's business. The system 100 allows for comments 460 to be entered to explain the metrics displayed as well as request additional information.

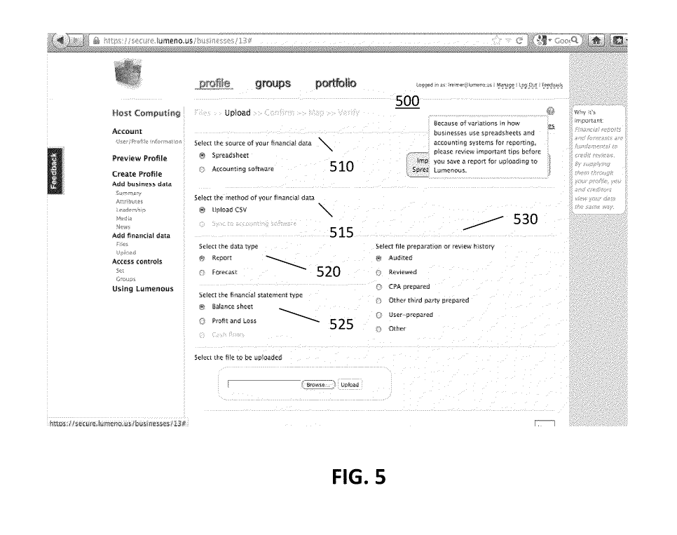

FIG. 5 illustrates the system interface 500 that allows a user to upload his or her firm's financial data. The presently disclosed system 100 accepts data periodically uploaded by users in the form of Comma Separated Values (CSV), a common export file format used by spreadsheet and accounting software 510, or by user-authorized syncing in the case of accounting software providers that support cloud data services 515. The application collects and/or tracks additional non-identifying attributes regarding the financial data including state or timeframe 520, type of report 525, and preparation method 530 whether by the user or another preparer.

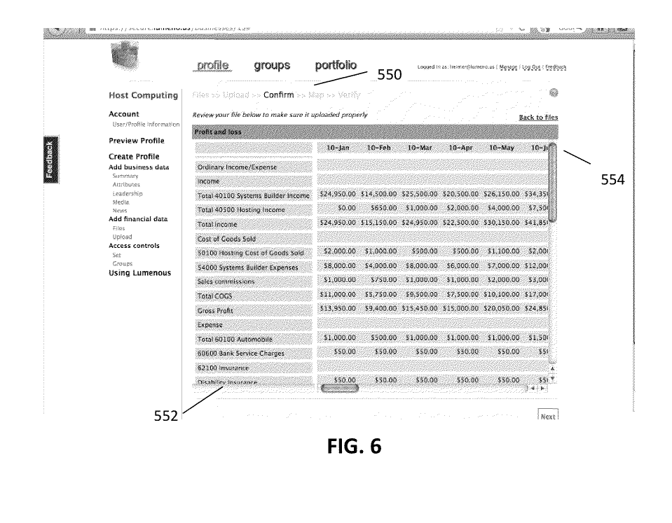

FIG. 6 illustrates the initial review display 550 that allows the user 244 to ensure his or her data have been properly uploaded. The original data are presented to the user 244 for review including original row label 552 and dates 554. The application maintains this record as a component of data verification and for the purpose of capturing collective mapping history that may organically drive to new standard taxonomies according to business attributes.

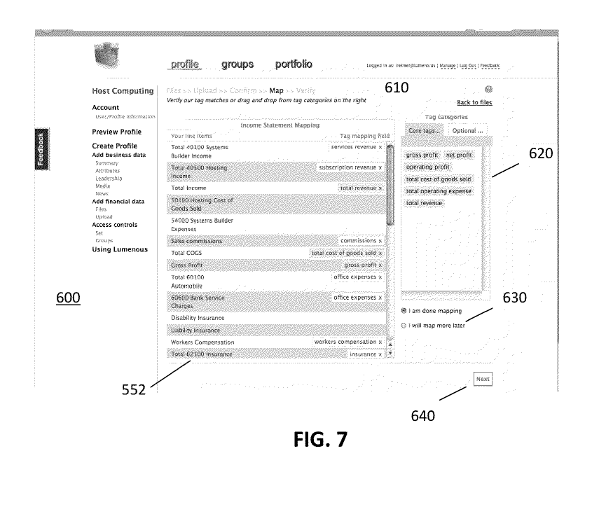

FIG. 7 illustrates the mapping interface 600 where a user 244 is shown the parsed, uploaded data and is able to adjust initial mapping through the use of “tags” and may be modified by mapping, adding, deleting or editing the linkages to accurately represent the firm's financials 610. In order to make modifications, the user 244 may simply drag and drop tags beside the original row labels 620. When such modifications are complete, the user 244 submits the data 630 to the system 100 and tag mappings are marked as “accepted” in the database. The next time the user 244 uploads a new version of the data, the tags mapped to each row are retrieved from the database and reused. In this way, unless the row labels have changed, the tagging will be exactly the same as the user's accepted mapping from the previous session. Tag mappings supplied and approved by users across the entire system 100 are also stored in a separate database that helps inform future parsing and mapping exercises 640. In this way the system 100 learns from users' efforts, improving the mapping from session to session across all the firms using the presently disclosed system 100. New tags can also be suggested by users 244 that, once they are approved by system administrators, will be added to the collection of tags available to all users 244 of the system 100. The net result is a universal system for mapping idiosyncratic financial data formats to a single standardized taxonomy and format that can adapt and learn from the actions of the users who supplied the original, non-normalized data.

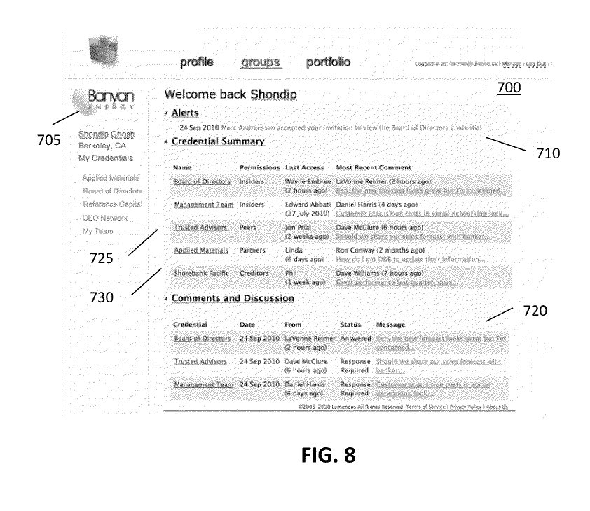

FIG. 8 illustrates the assessment interface 700 for viewing activities of the kind that are observed and analyzed for trust assessment. This feature is a component of the presently disclosed system 100, a web-based service that allows firms to create a profile, upload or sync data such as financial reports and selectively share that data with one or more creditors. Once the financial data for a firm is loaded into the present system as normalized, the user is able to share it selectively in its identified form (the name of the firm 705) with multiple creditors and stakeholders without additional effort. Each action taken by a user 244 will be logged 710 for analysis. For example, the system 100 tracks the frequency with which the firm uploads refreshed financial data, variances in data relative to previous uploads for similar periods 720, the number of company stakeholders invited 725, the number of creditors invited 730, and the level of acceptance and activity of all invited users 735. Interactions with invited creditors and stakeholders will also be analyzed 750. The system has a mechanism for participants to comment upon and discuss aspects of the firm's financial data and the degree and frequency of these interactions will be logged and analyzed 460.

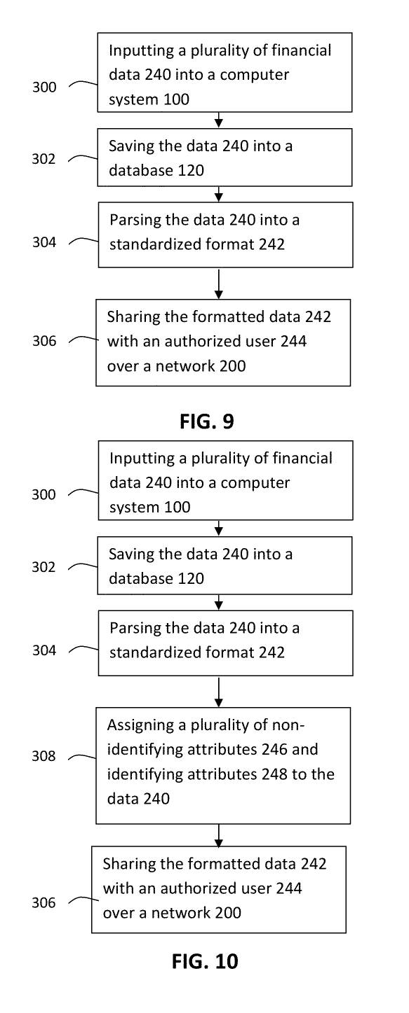

FIG. 9 illustrates an embodiment of the claimed method in which a plurality of user-supplied financial data are inputted 300, saved in a database 302 and parsed 304 by the system in order to attempt to normalize the user's data against a common taxonomy. Row labels are examined and simple string matching, synonym search and other linguistic parsing techniques are applied to find the best “guess” that maps a user's row label to a system-seeded taxonomy for financial data. The selected “tag” is stored in the system database alongside the user's original data but is initially marked as “unreviewed.” The formatted data 242 is shared 306 with a plurality of authorized users over a network 200.

FIG. 10 illustrates another embodiment of the claimed method in which each step of the input, saving, parsing, standardizing and sharing of the inputted data contributes non-identifying and identifying attributes 308.

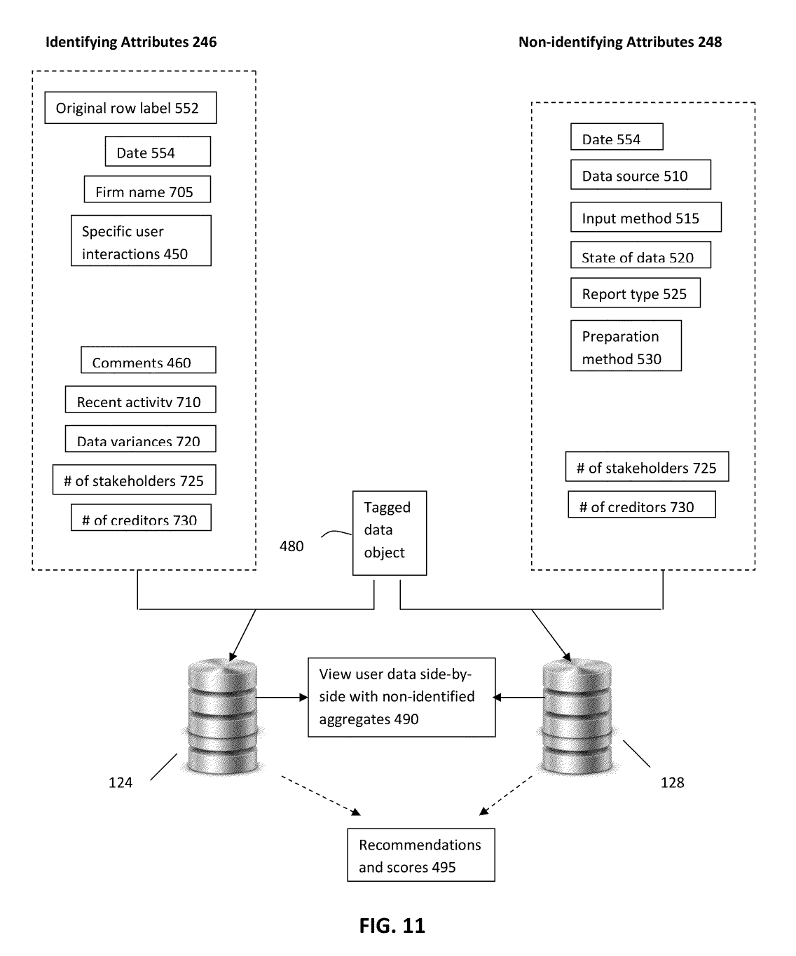

FIG. 11 illustrates another embodiment of the claimed method in which attributes are applied to each data object 480 as parsed and tagged and are stored a database for data associated with identifying attributes 124 and a database for data associated with non-identifying attributes 128. In this manner, the application optimizes the value of comparative data 490 and recommendations 495 without unnecessary and unwanted exposure of the firm's identity.

The presently disclosed system also aggregates activity logs across all the member firms. This large population of users will be used to create a baseline of ‘normal’ behavior. The specific patterns of behavior of a participating firm can be compared against the larger population of users to establish a kind of social proof of their data. If for example a firm has updated their data significantly less often, has not invited as many stakeholders, or has fewer, less active discussions than their peers, their data can be identified as less reliable. Creditors can request that the firm provide more data or explain these anomalies in order to complete their evaluation. This interaction will also be logged and will contribute to computing the overall trustworthiness and accuracy of the data. More stakeholders invited into and accessing the system to view the firm's data means more likelihood that inaccuracies will be spotted and rectified. Over time, with a track record of regular updates and ongoing interactions with partners, stakeholders and creditors, the firm's data can be presumed to be accurate and the present system will assign a score relative to the normative baseline to reflect that trustworthiness.

The disclosed embodiments are susceptible to various modifications and alternative forms, and specific examples thereof have been shown by way of example in the drawings and herein described in detail. It should be understood, however, that the disclosed embodiments are not meant to be limited to the particular forms or methods disclosed, but to the contrary, the disclosed embodiments are to cover all modifications, equivalents, and alternatives.

What is claimed is:

1. A computer implemented method for self-aggregation and validation of business information sharing, suitable for implementation on a processor, comprising:
inputting a plurality of financial data into a computer system;
saving the data into a database;
parsing the data into a plurality of discrete data objects;
applying attributes initially and over time;
reconstituting data objects according to a standardize-able taxonomy;
applying interactive machine-learning techniques to translate the semi-structured, non-standard financial data into a plurality of machine readable data,
sharing the formatted data with an authorized user over a network,
wherein said inputting, saving, parsing, applying, reconstituting, applying and sharing are performed by a processor.

2. The computer implemented method of claim 1, further comprising:
parsing a plurality of text from a plurality of semi-structured reports in order to break down the financial data into a plurality of discrete objects,
assigning a plurality of identifying attributes and a plurality of non-identifying attributes that are explicitly supplied and implicitly derived on a continuous basis to the data,
wherein the parsing and assigning is performed by a processor.

3. The computer implemented method of claim 2, further comprising wherein the parsing is applied to a balance sheet.

4. The computer implemented method of claim 2, further comprising wherein the parsing is applied to an income statement.

5. The computer implemented method of claim 2, further comprising wherein the parsing is applied to a cash flow statement.

6. The computer implemented method of claim 2, further comprising wherein the parsing is applied to a form containing business information substantially similar to financial reports in that numbers appear in cells and attributes for each cell are presented in text on the form.

7. The computer implemented method of claim 1, further comprising:
formatting data into a user selected semi-structured format similar to financial reports with no programming required,
wherein the formatting is performed by a processor.

8. The computer implemented method of claim 1, further comprising:
generating a plurality of user selected metrics,
wherein the generating is performed by a processor.

9. The computer implemented method of claim 2, further comprising:
generating a credit recommendation based on the aggregated financial data and the non-identifying attributes,
wherein the generating is performed by a processor.

10. The computer implemented method of claim 1, further comprising:
validating the financial data by creating a plurality of baselines against which to compare the input data,
wherein the validating is performed by a processor.

11. The computer implemented method of claim 1, further comprising:
verifying the financial data by capturing a plurality of sharing activities including invitations, responses, comments and ratings and
correlating such activities to patterns within any specific dataset,
wherein the verifying and correlating is performed by a processor.

12. The computer implemented method of claim 2, further comprising:
generating a credit recommendation based on analysis of user-specific activity,
wherein the generating is performed by a processor.

13. The computer implemented method of claim 2, further comprising:
generating a credit recommendation based on analysis of comparative activity,
wherein the generating is performed by a processor.

14. The computer implemented method of claim 2, further comprising:
generating a credit recommendation based on analysis of user-specific data patterns,
wherein the generating is performed by a processor.

15. The computer implemented method of claim 2, further comprising:
generating a credit recommendation based on analysis of comparative data patterns,
wherein the generating is performed by a processor.

16. The computer implemented method of claim 1, further comprising:
generating a credit recommendation based on analysis of comparative data patterns,
wherein the generating is performed by a processor.

17. A computer system for business information sharing, comprising:
a network accessible computer incorporating a processor;
a data storage system,
a software financial data application having a user input interface configured for electronically entering a plurality of financial data about the user's business,
wherein said application electronically communicates said financial data to a plurality of other system users as selected by the user,
wherein the processor is programmed and configured to format and display said financial information to a plurality of authorized users.

18. The system according to claim 17, further comprising wherein the data storage system is a cloud-based storage system.

19. The system according to claim 17, further comprising an interface configured to select a plurality of attributes for conducting user-filtered comparative analysis.
